(19) United States
(12) Patent Application Publication
(10) Pub. No.: US 2008/0189634 A1
(43) Pub. Date: Aug. 7, 2008

(54) Graphical Prediction Editor

(76) Inventors: Avadis Tevanian, Los Altos Hills, CA (US); Mark Stevans, Sunnyvale, CA (US); William Charles Hankinson, Mountain View, CA (US)

Correspondence Address: J. NICHOLAS GROSS, ATTORNEY, 2030 ADDISON ST., SUITE 610, BERKELEY, CA, 94704, US

(21) Appl. No.: 12/021,031

(22) Filed: Jan. 28, 2008

Related U.S. Application Data
(60) Provisional application No. 60/887,727, filed on Feb. 1, 2007.

(51) Int. Cl. G06F 3/048

(52) U.S. Cl. 715/764

(57) ABSTRACT

A graphical prediction editor for an Internet based community is adapted to collect and compile member votes/predictions. Aspects of an item graph can be customized and tailored by individuals to permit ease of data entry and review.

### RELATED APPLICATION DATA

The present application claims the benefit under 35 U.S.C. 119(e) of the priority date of Provisional Application Ser. No. 60/887,727 filed Feb. 1, 2007, which is hereby incorporated by reference. The present application is also related to U.S. application Ser. No. 11/753,128 titled Online Community-Based Vote Security Performance Predictor which is hereby incorporated by reference herein.

### FIELD OF THE INVENTION

The present invention relates to electronic methods of collecting, facilitating and compiling prediction information from online users concerning the performance or time-behavior of items. The invention has particular applicability to Internet based social networking environments in which members can vote on the anticipated price of a security (or other time varying asset) over defined time periods.

### BACKGROUND

A few Internet sites, including that operated by Motley Fool® permit their users to predict the future prices of securities. Generally speaking, however, these sites only compile/permit their members to view the individual stock predictions of other members. Examples of such types of systems can be seen in U.S. Publication Nos. 262118179; 26217994; and 27011073 which are hereby incorporated by reference herein.

While such prior art systems are useful, the mechanism(s) by which they solicit and collect user data are somewhat restrictive and unintuitive. Thus there is clearly a need for systems/methods which include a more elaborate and flexible interface for collecting prediction data.

### SUMMARY OF THE INVENTION

An object of the present invention, therefore, is to overcome the aforementioned limitations of the prior art.

A first aspect of the invention pertains to capturing/presenting data from/to a user concerning a predicted future performance of an item. One or more software/firmware routines are provided within a graphical interface which is preferably capable of:
1) receiving identifying data for an item to be subjected to an online community based vote;
2) receiving user predicted performance parameters in either or both numerical form and/or graphical form;
3) receiving time related parameters in either or both numerical form and/or graphical form;

the graphical interface preferably permits the user to specify a plurality of performance parameters over a plurality of corresponding time intervals.

In preferred embodiments one or more of the following options may also be present:
a) the graphical interface is configured to graphically present the user predicted performance parameter simultaneously with an online community aggregate predicted performance parameter and/or an actual performance parameter;
b) the graphical interface can be adapted to present analytical data, including charting data for the actual performance parameter;
c) the user can control the graphical interface to present past and/or future values of the user predicted performance parameter, the online community aggregate predicted performance parameter and/or the actual performance parameter;
d) different portions of the graphical interface can be highlighted with one or more indicators specifying one or more relationships between the past and/or future values of the user predicted performance parameter, the online community aggregate predicted performance parameter and/or the actual performance parameter;
e) the graphical interface can be adapted to graphically present an eligibility indicator at a time interval which is eligible to receive the user predicted performance parameter; moreover the user can specify the user predicted performance parameter by adjusting a position of the eligibility indicator within a graph display portion of the graphical interface;
f) the graphical interface dynamically changes and presents a new online community aggregate predicted performance parameter after capturing the user predicted performance parameter;
g) news items, stories and/or events relating to the item are also identified;
h) the item is characterized by a price which fluctuates with time;
i) the graphical interface further presents a prediction performance by the user and/or the online community;
j) the graphical interface further presents a predicted prediction to be entered by the user;
k) the item is a result of a sporting event and/or a political event;
l) the graphical interface further presents a prediction by a designated subgroup of the online community;
m) the user is required by the one or more software routines to provide a prediction for an item prior to viewing community data for such item;
n) the graphical interface further presents a prediction score indicating whether the item will achieve an online community prediction by a target date;
o) the interface presents a prediction score indicating the degree to which the user or community predicted value matched the actual item value at a past target date.

Another aspect of the invention pertains to capturing/presenting data from/to a user concerning a predicted future performance of an item. One or more software/firmware routines are provided within a graphical interface which is preferably capable of:
1) receiving identifying data for an item to be subjected to an online community based vote;
2) receiving performance parameters in either or both numerical form and/or graphical form;
3) receiving time related parameters in either or both numerical form and/or graphical form;

the graphical interface permits the user to specify a plurality of performance parameters which can change over different time intervals within a single data capture window.

Still another aspect concerns a method of presenting data to a user concerning a predicted future performance of an item. One or more software/firmware routines are provided within a graphical interface which is preferably capable of:
1) presenting identifying data for an item subjected to an online community based vote;
2) presenting one or more of a user predicted performance parameter, an online community aggregate predicted performance parameter and an actual performance parameter in graphical form;
3) presenting time related parameters in either or both numerical form and/or graphical form;
   the graphical interface preferably permits the user to visually compare the user predicted performance parameter, the online community aggregate predicted performance parameter and the actual performance parameter in graphical form.

In preferred embodiments one or more of the following options may also be present: the item is a financial instrument; alerts in the form of changes in the online community aggregate predicted performance parameter over a certain controllable threshold can be communicated to the user (either directly through the interface or some other communications channel—IM, SMS, email, etc.); and lists are presented identifying one or more of: the top N most predicted stocks; the top N stocks having the biggest changes in predictions over a certain period of time; the top N stocks with predictions deviating the most/least from actual prices.

Other aspects of the invention are directed to systems and hardware which are configured with suitable software routines so that the above methods can be implemented and enjoyed by members over a network connection, preferably the Internet.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Moreover while described in the context of an equities price prediction system, it will be apparent to those skilled in the art that the present teachings could be used in any Internet based application that can benefit from a community prediction of some form for an item.

### DESCRIPTION OF THE DRAWINGS

FIG. 1 is simplified block diagram of the various components and inputs/outputs used in a preferred embodiment of the invention;

FIG. 2 is an illustration of a preferred subscriber-specific interface employed in the present invention that is adapted for assisting users/subscribers to set up and view their individual predictions for the future performance of stocks/securities.

FIG. 3 is an illustration of a graph/chart generated in accordance with a preferred embodiment of the present invention.

### DETAILED DESCRIPTION

A new system and method for the specification and display of time-based predictions is presented, in the form of a graphical prediction editor (GPE). Many systems/methods currently exist to allow for the specification and display of predictions but they suffer many shortcomings including flexibility and ease of use. The present invention makes use of interactive graphical charts to display predictions that have been made in the past as well as predictions for the future, the latter of which can optionally be edited. This method allows for the simultaneous display of multiple prediction time values, including the past and future making it easy to see how predictions can change over time. Further, eligible predictions can be updated with results seen in real-time.

Prior to the present invention, the collection of predictions has generally been in the form of asking one or more explicit questions of an individual, followed by the tabulation of the results of the question. A question might be a simple plain text question with a multiple-choice answer or an answer that is some kind of value such as a number. In some cases, it is useful to make predictions given a certain time base. For example, a survey that wishes to collect predictions might ask “what do you think a stock price will be on January 1?” In a case like this each participant in the survey would make a prediction and then the results would be aggregated using a mathematic computation like a mean or median to produce a desired overall prediction.

Many topics for which predictions are interesting have different answers that vary over time. For example, on December 1 a participant might think a stock price would be 50 on January 1 of the following year, and 70 on June 1. In general prior art systems typically allow for predictions for time periods extending from the present day to some future date. However, they do not allow for predicting multiple price points over a predetermined period. Prior to this invention, collecting multiple predictions like this would involve asking multiple questions. Nor do they allow for predicting price ranges at different time intervals in the future—i.e., as in the above example of a current date of December 1, asking a participant to predict the price in the time range of January 1 to June 1 of the following year.

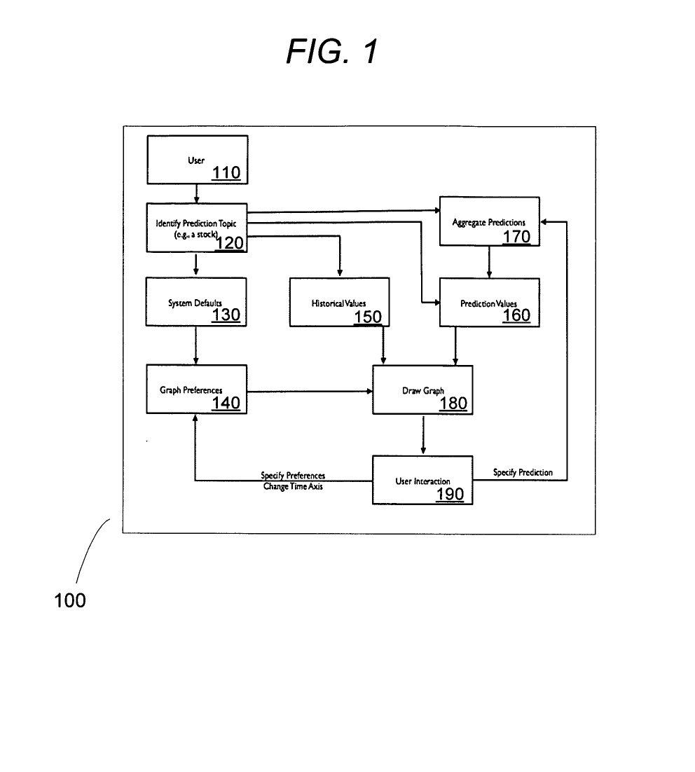

A simplified block diagram of the various components and inputs/outputs used in a system 100 of a preferred embodiment of the invention is shown in FIG. 1. A user 110 identifies an item or topic 120 for which a prediction (or sentiment) is to be provided. A set of default parameters 130 are generated for the stock which are customized for such application. In other words, a format for time/price axes, a scale to be used, etc. are provided in an appropriate form for the interface used by the user. The user can then modify these defaults, as well as specify other graphical preferences 140, such as labels, colors to be used, an overall time scale, etc. The system defaults and graphical preferences will of course vary from application to application.

Historical values 150 are then retrieved (from any suitable database) to be used to assist in forming the graph of the prediction for the item. The user's prediction data 160 is also logged by a prediction aggregator 170 which compiles and tabulates data for all predictions presented and collected for users of the system. The graph for the stock is then presented by a graphical drawing engine 180, again in a format suitable for the user's computing interface. Control over the predictions, graphs, etc. is implemented by an interaction routine 190 that allows a user to modify preferences, time axes, predictions, etc., and cause new graphs to be generated.

In a preferred embodiment these components are implemented in an online Internet site for collecting crowd sentiment/predictions, such as that found at wwwdotpiqqemdotcom. It will be understood that the invention is not limited to any particular hardware implementation in this respect, and that such components in FIG. 1 can be implemented preferably by one or more software routines and databases executing (or residing) on a combination of hardware platforms, including conventional Internet servers. Some aspects of the invention may be implemented in part on client side devices, such as a personal computer, a cellphone, PDA, consumer electronic device, etc. Again those skilled in the art will appreciate that the particular hardware is not critical to the operation of the invention.

In a preferred embodiment the GPE is used in association with online group/community/crowd prediction systems such as described in related U.S. application Ser. No. 11/753,128 referenced above. It should be noted nonetheless that the invention could be used in connection with other systems which would benefit from the ease of use and functionality afforded by the present invention.

For example while the preferred embodiment is described in connection with the editing of stock (equity) prices over time, the invention could be applied to any field in which it is desirable to allow persons to make predictions about an event/item which has at least one time varying characteristic. As an illustration, a sports based application could be implemented which allows persons to make predictions on the performance of a particular team/player over time, including a relative position in the standings, game by game, etc. The price/economic performance of other assets may be predicted and tracked, such as for real estate, art, raw materials, produce, interest rates, precious metals and the like. Sales of items could be predicted/tracked; physical variables such as temperature could be predicted and tracked. Countless other examples will be apparent to those skilled in the art from the present teachings.

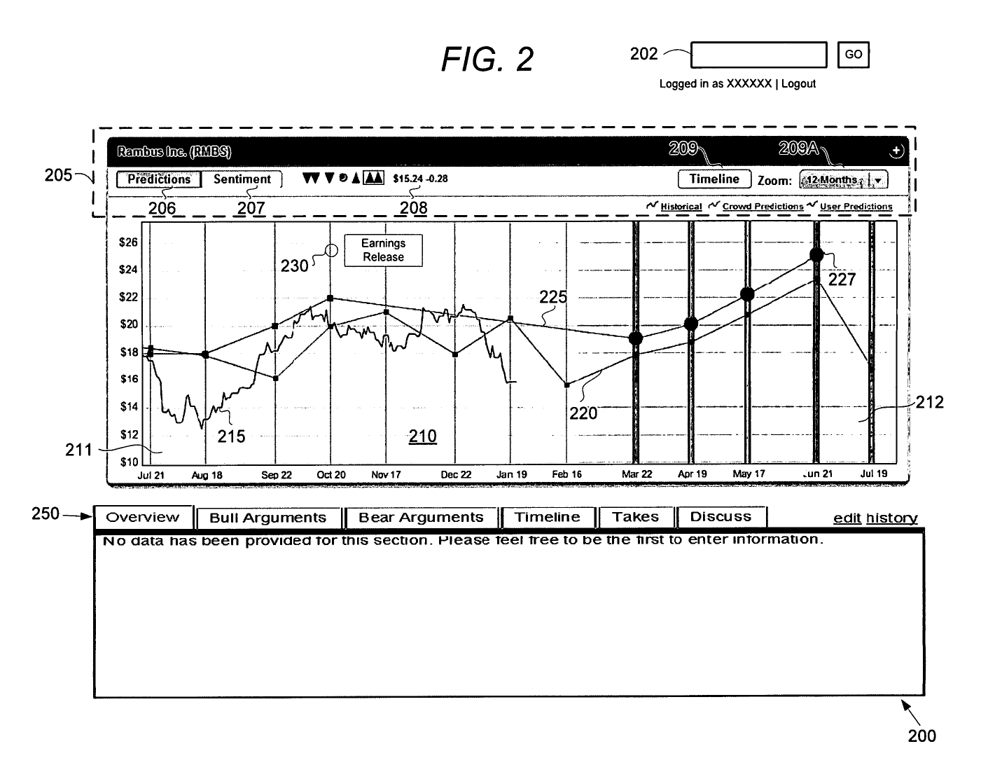

FIG. 2 illustrates a preferred embodiment of a graphical editor 200 used in the present invention. This interface contains a search field 202, a navigation bar 205, a graph area 210 and a notes section 250. These aspects of the interface are elaborated below.

### Security (Item) Search

Search field 202 permits a user to retrieve and enter data for a security based on a symbol, prefix, or other suitable identifier. This can be done using any conventional search engine and accompanying database.

### Navigation Area 205

Navigation bar 205 includes a number of useful components, including two different viewing modes: a prediction viewing/collection mode 206, and a sentiment viewing mode 207. The set of five symbols 208 appear as short hand icons for quickly expressing the user's sentiment, known as Quick Piqqs^{SM}. A timeline control parameter 209 is also selectable and controllable to toggle the timeline bar on or off, and to view different time periods.

A zoom selector 209a allows the user to change the resolution of the data being viewed. For a Prediction View, the user may view either a 6, 12, or 24-month view, split evenly into past and future. For a Sentiment view, the user may view the most recent 3, 6, or 12 month spans. The user may also view the entire sentiment history (the time since the first Quick Piqqs^{SM} was recorded for that security).

In addition, other useful identification information is presented in this area of the interface. The name of the Security and its ticker symbol are displayed at the top left of Navigation bar 205. A circular icon in the top right can be used to add/remove a Security from your Favorites portfolio. The user is allowed to toggle between Prediction View and Sentiment View with selectors 206, 207 underneath the Security's name. The current price of the Security and today's change are listed next to the Quick Piqqs^{SM} icons. Those skilled in the art will appreciate that other data could be included as well.

### Interactive Graph Region 210

Interactive graph region 210 permits the user to both see and provide prediction data as explained below. The format and presentation is geared to facilitate and expedite the collection of group sentiment.

Generally speaking this aspect of the invention shows the historical performance of a security (its closing price history), any past or future predictions made by the community, and the history of the crowd's sentiment for that security. A user's historical predictions are also preferably shown as well if desired for both Price Piqqs^{SM} and Quick Piqqs^{SM}. In some instances the interface may also show the user a score or visual feedback (not shown) indicating how closely their historical prediction data aligns with the actual stock price. In addition, the user can enter and edit their own Predictions for future pricing (a Price Piqq^{SM}), change their Quick Piqqs^{SM}, and add/remove Securities from your Favorites portfolio.

To collect predictions on the items (in a preferred embodiment, prices for equities) an interactive graph is created within region 210. On the x-axis of graph 210 is a time base. This will vary based on the predictions to be collected, and can be adjusted by the system, including with appropriate annotated intervals, in accordance with the item in question and the desired time horizon contemplated for a prediction period. For example in the case of stocks one approach may be to limit the time base to a 1 year period with allowable predictions for the price of the equity provided for every month, every week, etc. Nonetheless the time base of graph 210 need not be fixed and can be under user control allowing the user to decide which predictions to view and/or specify. Accordingly a user may elect to only complete a portion of the predictions and for only some of the time period otherwise allowable within the allowable prediction period.

The y-axis is a representation of the possible data values for the answer to the question underlying the prediction. It could be a range of numbers, e.g., a stock price, or some other value that can reasonably be ordered, e.g. “poor, average, good.” Again the system can provide a set of default delineations for such axis based on the type of item being evaluated, with functionality being provided to the user to alter such values.

Generally speaking the user is allowed to create picks (votes, predictions) either through direct manipulation of graphing parameters within interface 200, or by use of the Quick Piqqs^{SM} icons noted earlier. These icons include:
Red double down-arrow—Strongly negative Sentiment
Red single down-arrow—Negative Sentiment
Yellow disc—Neutral Sentiment
Green single up-arrow—Positive Sentiment
Green double up-arrow—Strongly positive Sentiment

To make a Quick Piqq^{SM}, the user simply clicks on the icon most closely matching their sentiment. This Quick Piqq^{SM} preferably lasts some short period (i.e., 30-90 days) before expiring, though they may renew it at any time by clicking on a Quick Piqqs^{SM} icon again. There is no penalty for changing one's vote (as each user only gets one vote per security), so users are free to change it as often as they like. The Quick Piqqs^{SM} feature is a basic unit of data within the invention, and in preferred embodiments of the invention the user is required to provide at least some prediction data (such as a Quick Piqq^{SM}) before they are granted access to the ability to enter detailed Price Piqq^{SM} or view crowd sentiment.

The Quick Piqq^{SM} icons cause the graph to display a prediction for the user based on some underlying correlation of sentiment to share price. For example a strongly negative sentiment may cause the system to plot a decrease of 10% for the stock price over the defined time period, a Negative Sentiment may plot a decrease of 5%, and so on. The positive sentiments would show corresponding increases. Other values can be used of course depending on the application.

The prediction based view 206 allows for viewing all of the actual Price Piqq^{SM}—including those from the user and the calculated crowd values. These values are represented on two curves, namely, a Crowd Prediction curve 220 and a User Prediction curve 225.

The Crowd Prediction curve 220 is preferably shown in one color, while the User Prediction curve is shown in a second color. Other forms for viewing the curves can be used, such as by different shadings, patterns, shapes, etc.

The Crowd Prediction curve 220 represents a calculation based on results of past predictions by the community of members, either by groups, individual members, or aggregated. In some instances the data can be filtered so that the predictions of individual tribes (as explained in related application Ser. No. 11/753,128) can be presented for review. The data can be aggregated by conventional averaging of the votes, by some kind of weighting, or a number of other alternative algorithms well-known in the art.

The User Prediction curve 215 allows an individual using interface 200 to graphically enter/view prediction data. The user input is facilitated by sliding points 227 which can be manipulated by a mouse or other pointing device. For ease of reference the interface preferably displays the selected stock price visually and dynamically in numerical form as the user positions the point along the y-axis.

Thus when moving the mouse over a slider, the cursor preferably changes to an “Add Piqq” cursor. A tooltip above the cursor indicates to the user the exact price he/she is hovering over, as well as how great a change this price represents from the stock's current trading price. To make a prediction, the user simply clicks on the slider. A data point will be placed at the end of the Add Piqq^{SM} cursor.

Preferably there are two ways to edit a prediction. The user can click on an existing Piqq^{SM} and drag it to a new location or simply click on the slider at the desired price and the Price Piqq^{SM} will automatically slide into the proper position.

To delete a Price Piqq^{SM}, the user clicks on the prediction and drags it off the slider. When the user drags the mouse far enough away from the slider, a tool tip will show a Price Piqq^{SM} with a red “X” on it. By releasing the mouse while this cursor is active, the Piqq^{SM} will be deleted.

While these are preferred implementations for adding and modifying predictions, it will be apparent to skilled artisans that a variety of techniques could be employed with the present invention.

In a preferred embodiment, the user is required to provide a prediction for an item (a stock price performance) before the system allows him/her to see other member's predictions. This serves two purposes: 1) it encourages and ensures that the system is constantly updated with new and fresh content; 2) it ensures autonomy of voting by preventing the user from being biased by other opinions.

For comparison to historical values, the closing price history 215 is preferably shown in a third color. These historical values 215 represent an actual stock price in the case of an equities prediction system.

All three types of values (crowd prediction, user prediction, historical) can be toggled on/off as seen in Navigation area 205.

Also shown in graph area 210 are two differently patterned regions representing closed dates 211 and open dates 212. These correspond to time periods for which prediction/sentiment data has been/can be expressed respectively. Preferably the open dates extend at least 30 day into the future to permit the user to enter or modify votes/predictions.

### Notes Area 250

As alluded to earlier, this section of the interface is intended to provide users with an easy way to draft/journal their thoughts regarding an item, and to see content provided by other members. These sections include:

Overview

This is a User Note, intended to provide a fair and balanced summary of the security from an investment point of view. This section should be fact-based, reserving opinions for the next two notes.

Bull Arguments

This Note allows all users who believe investors should take a Bullish (price-positive) stance on a stock to collaboratively outline the reasons why other users should also take that view.

Bear Arguments

This note allows all users who believe investors should take a Bearish (negative) position to list their arguments.

Timeline

The timeline allows users to enter short descriptions of significant events which occurred (or will occur) on specific dates. Events entered in the timeline will appear on the Timeline bar inside the Graphical Piqq Editor. By default, the timeline tab starts in View Mode, which simply shows an ordered list of all events which have been entered for an security. By clicking the “edit” button, one can enter Edit Mode.

Once in edit mode, each timeline event has an “edit” link next to it. In addition, there is a “Timeline Options” box which allows one to show/hide deleted timeline events as well as create new ones. When clicking on one of the “edit” links or create a new timeline event, the user is presented with an editing display which allows him/her to see both the history of events for that day and a text field which will allows them to update that day's event(s). If you the user chooses, they may also revert a timeline event to a previous version. To delete an event from the timeline, one simply removes all of the event's text and submit the changes.

Takes

A User Take is one User's official opinion of a security. Each user is preferably allowed only one User Take for each security, and should be viewed as a stable opinion of that security. Note that though each user can preferably only have one single Take on a Security, they may enter any number of comments in the discussion section.

Discuss

This section permits user to enter comments regarding the security and to view the comments of other Users.

### Sentiment View

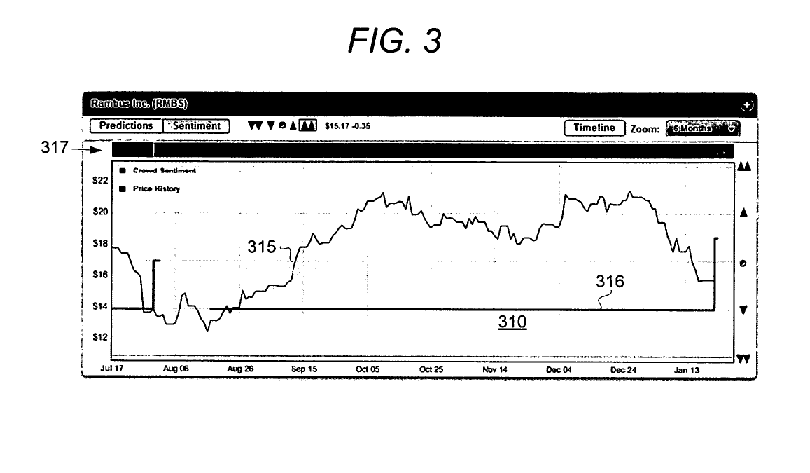

In the sentiment view mode—which is selected by toggling field 207 and shown in FIG. 3—the system shows the user how the sentiment has changed over time in a graph 310. Coupled with the Timeline, the user can determine what effect major events had on the crowd's sentiment.

Like the Prediction View, a solid black line 315 preferably is used to represent the closing price history of a security. A different color (preferably orange) line 316 represents a closing Sentiment of a security, which means it was the crowd average at the end of that day.

Also available within this interface, if desired, is a personal Sentiment History 317. This is a running record of the user's Quick Piqqs™. Like the Timeline, it lines up perfectly with the chart below. When space permits, the Quick Piqq icon is drawn on the corresponding stretch of time—otherwise, different colors can be used as visual representations of Quick Piqqs:
Green—Double Up
Light Green—Single Up
Yellow—Neutral
Light Red—Single Down
Red—Double Down

Again other colors and formats can be used if desired.

### OTHER VARIANTS AND EMBODIMENTS

In some instances the invention may display its own prediction of what it expects the user to predict as the performance. This can be done based on tracking historical guesses and with conventional collaborative filtering as noted in related application Ser. No. 11/753,128.

An additional data field (not shown) for a prediction score associated with the particular subscriber's prediction for a particular equity can also be provided if desired. In a preferred embodiment, for any equity for which expired predictions were entered by member, a column displays a metric indicating the relative accuracy of the predictions. A score of 100 for example indicates that the actual prices exactly matched all predictions. Other variations will be apparent to those skilled in the art.

While not explicitly shown in FIG. 2, the invention can also generate and display a prediction that such security will indeed achieve an aggregated prediction performance, and/or the user's predicted performance. This prediction can be based on an overall accuracy parameter associated with said community, again, which is preferably derived from analyzing historical data (or the track record) for the community as a whole for particular stocks or based on some other measurable metric.

In a preferred embodiment a voter's track past record is not used as a predictor of results or for the mapping of the aggregated data (although using such data could be used for extra analysis it is not required for this invention). Each vote is given equal weighting regardless of such past performance. This causes the system to truly rely on the collective intelligence of all participants, with no favoritism toward a prior record.

Each of the above variant elements may be optionally displayed. For example, only past and future predictions might be displayed; or, only historical values and future predictions might be displayed. Furthermore, if desired, a user can overlay other conventional charting analytic graphs/tools (not shown), such as Bollinger bands, moving averages, and similar charting aids which monitor and predict expected price behavior. For some applications it may be desirable to permit the user to annotate the graph, as is done with conventional charting software, to identify trendlines and other commonly used charting tools.

In addition, company/item related events 230 can also be displayed in the charting region to identify meaningful milestones. Thus, for example, the issuance of press releases, earnings reports, SEC filings, etc., can be projected for ease of reference. Future events such as upcoming trade shows, earnings reports, conference calls, product releases, etc., can all be mapped as well to facilitate the collection of relevant prediction data. This is particularly useful in the context of public securities, since earnings reports often tend to affect the underlying price in a significant fashion.

The timeline events can be events entered by other users from the individual Security pages (for info on adding events, see below), or they can be added automatically by some form of data mining/extraction routine. The dates represented in the timeline match up exactly with the charts, so the date labels are not repeated. Mousing over an individual timeline event will display that event in an overlay while also activating any data points on the chart below.

The size/scaling of the viewable portion can be adjusted automatically to be appropriate for the computing platform on which it is operating. Labels and other graphical items may be adjusted as well to be optimized for a particular application i.e., desktop, laptop, PDA, and other portable/hand held devices. Predefined markers can be provided on the axes, as shown, to help users approximate where to place the mouse to make predictions. The markers can illuminate, glow or otherwise provide visual feedback to permit ease of data entry.

In some embodiments the relationship of the predicted/actual votes can be identified/highlighted in different colors. For example, in regions of the graph where the predicted crowd value and the actual value are relatively close (such as in the June 28 to July 21 timeframe in FIG. 2) the chart could highlight this agreement in a particular color or indicator (not shown). Similarly in areas of disagreement (such as in the July 21 to August 24 timeframe) another color or indicator could be used. Other examples will be apparent to those skilled in the art, and the invention is not limited in this respect.

Future predictions may be specified, or updated, interactively on the graph. In a preferred embodiment certain future time values will be pre-selected for the collection of prediction data. For example, if it is January 1 the system may have pre-selected that February 15, March 15, April 15, etc. are all eligible for the entry of a prediction. At these dates on the graph, a graphical indicator (shown above as a round dot in FIG. 2) can then be dragged up or down by the user in order to specify a prediction. When such a prediction has been entered, the system will recompute the aggregation of all predictions and update the graph accordingly.

Additional statistical data could be derived over time to measure and identify community biases (positive and negative) for particular securities. These biases could also be overlaid/presented within interface 210 so that the system can present its interpretation or prediction based on some offset of the community based prediction. Future price predictions can also be projected for later target dates based on the data provided for the current open target dates. Again those skilled in the art will appreciate that the actual visual characteristics of region 210 can be tailored to any specific application.

Since multiple prediction time-values can be displayed on graph 210 at once it is possible to easily enter such multiple “votes” and to easily enter and view trends. In other instances it may be beneficial to employ “alerts” as is done with real stock prices, to inform users (by email, instant message or other electronic communication) of changes in the predicted price which exceed predetermined thresholds set by the user. As an instance, a user may ask to be told of changes above 5% for stock A over the course of a 24 hour period, or if the prediction exceeds a certain value. Again other controls can be configured as well.

In a preferred embodiment votes/predictions can only be made by registered users. This serves to generate a sense of accountability amongst the voters/predictors. It is also easier, of course, to track and maintain timely profiles. In another embodiment voters/predictors are not registered. This allows for completely anonymous voting. The two methods may or may not generate different results, but both are valid ways to collect the data and can be used to generate correlations. In some instances the two disparate populations can be tracked/evaluated separately and presented for comparison.

In a preferred embodiment the graphical data is provided for a fee to registered subscribers. In fact, some data may still be provided for free to any user (advertising supported) while other premium data is provided to any paid subscriber. Examples of possible premium data would be most recent predictions (as opposed to those released on a time delay) or predictions that surpass certain trigger levels (e.g., number of voters having voted or large correlations above certain thresholds).

In another form of output the data/graphs and any analysis are provided on a limited basis to professional managers of the underlying assets, such as hedge fund managers. The data and results are treated as highly valued information and distribution is limited.

In yet another form of output the data/graphs are kept confidential and used as a form of proprietary information. This information is used for direct trading or in conjunction with a proprietary hedge fund, or related hedge funds.

None of these forms of distribution are mutually exclusive and in fact they can be combined. For example, data could be made available via a subscription to anyone wishing to pay while a hedge fund that trades solely on this information exists in parallel.

It will be understood of course that the components of FIG. 2 could be varied significantly depending on the overall desired functionality and aesthetic presentation. Other portions of main interface could include other text/graphics content of course, including advertising in different forms, and it will be understood that this is just intended to communicate some of the more material aspects presented to the user during a data collection/presentation session.

Finally, as with some conventional prediction systems used in the art, it will be helpful (and entertaining in some instances) to provide rankings, lists and other data pertaining to the crowd predictions for easy review. As an example, the system may identify the top N most predicted stocks, the top N stocks having the biggest changes in predictions over a certain period of time, the top N stocks with predictions deviating the most/least from actual prices, etc. Additional examples will be apparent from the present disclosure, and in the above referenced Ser. No. 11/753,128.

In non-equity environments the interface may present the outcome of an event. For example the score of a sports game may be predicted across multiple periods. The main interface can allow members to make picks by any of a variety of possible mechanisms—through quick iconic entries, or if desired, through more elaborate graphical charting techniques. The choice of voting entry mechanism can be adjusted for any particular application.

When multiple elements are displayed the viewer is able to easily see relationships between past predictions and actual values (i.e., past accuracy of predictions). The viewer can also see future trends, all in the context of past predictions and historical values, all within an easily viewable portion of the graphical interface, and preferably within a single screen. The use of a visual graph permits users to easily and immediately grasp the expected crowd direction for an item.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of capturing data from a user concerning a predicted future performance of an item comprising:
providing one or more software routines within a graphical interface which is capable of:
1) receiving identifying data for an item to be subjected to an online community based vote;
2) receiving user predicted performance parameters in either or both numerical form and/or graphical form;
3) receiving time related parameters in either or both numerical form and/or graphical form;
wherein said graphical interface permits the user to specify a plurality of performance parameters over a plurality of corresponding time intervals.

2. The method of claim 1, wherein said graphical interface is configured to graphically present said user predicted performance parameter simultaneously with an online community aggregate predicted performance parameter and/or an actual performance parameter.

3. The method of claim 2 wherein said graphical interface is configured to present analytical data, including charting data for said actual performance parameter.

4. The method of claim 2 wherein the user can control said graphical interface to present past and/or future values of said user predicted performance parameter, said online community aggregate predicted performance parameter and/or said actual performance parameter.

5. The method of claim 1 wherein different portions of said graphical interface can be highlighted with one or more indicators specifying one or more relationships between said past and/or future values of said user predicted performance parameter, said online community aggregate predicted performance parameter and/or said actual performance parameter.

6. The method of claim 1, wherein said graphical interface is configured to graphically present an eligibility indicator at a time interval which is eligible to receive said user predicted performance parameter.

7. The method of claim 6, wherein said user can specify said user predicted performance parameter by adjusting a position of said eligibility indicator within a graph display portion of said graphical interface.

8. The method of claim 1, wherein said graphical interface dynamically changes and presents a new online community aggregate predicted performance parameter after capturing said user predicted performance parameter.

9. The method of claim 1 wherein news items, stories and/or events relating to the item are also identified.

10. The method of claim 1 wherein said item is characterized by a price which fluctuates with time.

11. The method of claim 1 wherein said graphical interface further presents a prediction performance by the user and/or said online community.

12. The method of claim 1 wherein said graphical interface further presents a predicted prediction to be entered by the user.

13. The method of claim 1 wherein said item is a result of a sporting event and/or a political event.

14. The method of claim 1 wherein said graphical interface further presents a prediction by a designated subgroup of the online community.

15. The method of claim 1 wherein said user is forced by said one or more software routines to provide a prediction for an item prior to viewing community data for such item.

16. The method of claim 1 wherein said graphical interface further presents a prediction score indicating whether said item will achieve an online community prediction by a target date.

17. A method of capturing data from a user concerning a predicted future performance of an item comprising:
providing one or more software routines within a graphical interface which is capable of:
1) receiving identifying data for an item to be subjected to an online community based vote;
2) receiving performance parameters in either or both numerical form and/or graphical form;
3) receiving time related parameters in either or both numerical form and/or graphical form;
wherein said graphical interface permits the user to specify a plurality of performance parameters which can change over different time intervals within a single data capture window.

18. A method of presenting data to a user concerning a predicted future performance of an item comprising:
providing one or more software routines within a graphical interface which is capable of:
1) presenting identifying data for an item subjected to an online community based vote;
2) presenting one or more of a user predicted performance parameter, an online community aggregate predicted performance parameter and an actual performance parameter in graphical form;
3) presenting time related parameters in either or both numerical form and/or graphical form;
wherein said graphical interface permits the user to visually compare said user predicted performance parameter, said online community aggregate predicted performance parameter and said actual performance parameter in graphical form.

19. The method of claim 18, wherein said item is a financial instrument.

20. The method of claim 18, wherein alerts in the form of changes in said online community aggregate predicted performance parameter over a certain controllable threshold can be communicated to said user.

21. The method of claim 18, further including a step of presenting a list identifying one or more of:
the top N most predicted stocks;
the top N stocks having the biggest changes in predictions over a certain period of time;
the top N stocks with predictions deviating the most/least from actual prices.

22. A system for capturing data from a user concerning a predicted future performance of an item comprising:
a graphical interface;
one or more software routines adapted to receive data within said graphical interface, including:
1) identifying data for an item to be subjected to an online community based vote;
2) user predicted performance parameters in either or both numerical form and/or graphical form;
3) time related parameters in either or both numerical form and/or graphical form;
wherein said graphical interface permits the user to specify a plurality of performance parameters over a plurality of corresponding time intervals.

23. A system for capturing data from a user concerning a predicted future performance of an item comprising:
a graphical interface;
one or more software routines adapted to receive data within said graphical interface, including:
1) identifying data for an item to be subjected to an online community based vote;
2) performance parameters in either or both numerical form and/or graphical form;
3) time related parameters in either or both numerical form and/or graphical form;
wherein said graphical interface permits the user to specify a plurality of performance parameters which can change over different time intervals within a single data capture window.

24. A system for capturing data from a user concerning a predicted future performance of an item comprising:
a graphical interface;
one or more software routines adapted to process data within said graphical interface, including:
1) identifying data for an item subjected to an online community based vote;
2) presenting one or more of a user predicted performance parameter, an online community aggregate predicted performance parameter and an actual performance parameter in graphical form;
3) presenting time related parameters in either or both numerical form and/or graphical form;
wherein said graphical interface permits the user to visually compare said user predicted performance parameter, said online community aggregate predicted performance parameter and said actual performance parameter in graphical form.
